(19) United States
(12) Patent Application Publication
(10) Pub. No.: US 2024/0205169 A1
(43) Pub. Date: Jun. 20, 2024

(54) METHOD AND ELECTRONIC APPARATUS WITH PARALLEL SINGLE-STAGE SWITCHING

(71) Applicant: Samsung Electronics Co., Ltd., Suwon-si (KR)

(72) Inventors: Young Jun HONG, Suwon-si (KR); Yong In LEE, Suwon-si (KR); Wonseok LEE, Suwon-si (KR)

(73) Assignee: Samsung Electronics Co., Ltd., Suwon-si (KR)

(21) Appl. No.: 18/354,341

(22) Filed: Jul. 18, 2023

(30) Foreign Application Priority Data
Dec. 20, 2022 (KR) 10-2022-0179566

(51) Int. Cl. H04L 49/15

(52) U.S. Cl. CPC H04L 49/15

(57) ABSTRACT

An electronic apparatus includes a plurality of processor device-memory device groups, and each of the plurality of processor device-memory device groups includes a plurality of memory devices respectively comprising one or more memories, a plurality of processor devices respectively comprising one or more processors, and a plurality of switches. Each of the plurality of switches includes a plurality of ports. Each of first memory devices included in a first processor device-memory device group of the plurality of processor device-memory device groups is connected to a first subset of ports of one switch of first switches included in the first processor device-memory device group, and to a first subset of ports of one switch of second switches of the plurality of switches included in a second processor device-memory device group of the plurality of processor device-memory device groups.

### CROSS-REFERENCE TO RELATED APPLICATIONS

This application claims the benefit under 35 USC § 119(a) of Korean Patent Application No. 10-2022-0179566, filed on Dec. 20, 2022, in the Korean Intellectual Property Office, the entire disclosure of which is incorporated herein by reference for all purposes.

### BACKGROUND

### 1. Field

The following description relates to a method and electronic apparatus with a parallel single-stage switching.

### 2. Description of Related Art

Along with an increase in the complexity of operations being implemented by a large-scale computer system, information exchanges are being frequently performed between processor devices and/or memory devices. In a data center or super computer, for example, approximately 100 to 400 processor devices may be installed in a typical rack.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one or more general aspects, an electronic apparatus includes a plurality of processor device-memory device groups, and each of the plurality of processor device-memory device groups includes a plurality of memory device devices respectively comprising one or more memories, a plurality of processor devices respectively comprising one or more processors, and a plurality of switches. Each of the plurality of switches includes a plurality of ports. Each of first memory device devices included in a first processor device-memory device group of the plurality of processor device-memory device groups is connected to a first subset of ports of one switch of first switches included in the first processor device-memory device group, and to a first subset of ports of one switch of second switches of the plurality of switches included in a second processor device-memory device group of the plurality of processor device-memory device groups.

The first memory device devices may be connected to a first switch of the first switches and a first switch of the second switches.

The first processor device-memory device group and the second processor device-memory device group may be disposed to be physically most adjacent to each other.

The first processor device-memory device group and the second processor device-memory device group may not be physically most adjacent to each other but may be logically adjacent to each other.

The first processor device-memory device group and the second processor device-memory device group may be disposed to transmit electrical signals between each other.

In each of the plurality of processor device-memory device groups, an equal number of connections may exist between a corresponding plurality of memory devices and a corresponding plurality of switches.

Any of the plurality of switches may not be connected to another of the plurality of switches.

A number of the plurality of memory devices in any one of the plurality of processor device-memory device groups may be determined based on a condition that a product between a number of the plurality of processor device-memory device groups, a number of switches in a corresponding processor device-memory device group of the processor device-memory device groups, and a number of the plurality of ports of the plurality of switches in the corresponding processor device-memory device group does not exceed a product between the number of plurality of switches in the corresponding processor device-memory device group and a number of a subset of ports in the corresponding processor device-memory device group connected to a corresponding plurality of memory devices.

Numbers of the plurality of memory devices in each of the plurality of processor device-memory device groups may be equal.

Numbers of the plurality of switches in each of the plurality of processor device-memory device groups is equal.

A second subset of ports of the one switch of the first switches may be connected to a corresponding processor device of the plurality of processor devices.

A number of the plurality of processor devices may be less than or equal to a value obtained by dividing a difference between a total number of ports of the plurality of switches and a total number of ports of the plurality of memory devices by a number of ports of a processor device of the plurality of processor devices.

A number of the plurality of processor devices may be a multiple of a predetermined integer number.

Each of the plurality of switches may be a compute express link (CXL) switch.

Each of the plurality of switches may be a single-stage switch.

Each of the plurality of processor devices may include a plurality of ports, and each of first processor devices of the plurality of processor devices in the first processor device-memory device group may be connected to a second subset of ports of the one switch of the first switches, and a second subset of ports of the one switch of the second switches included in the second processor device-memory device group.

The electronic apparatus may be a storage device.

In another one or more general aspects, an electronic apparatus includes a plurality of processor device-memory device groups, and each of the plurality of processor device-memory device groups includes a plurality of memory devices respectively comprising one or more memories, a plurality of processor devices respectively comprising one or more processors, and a plurality of switches. Each of the plurality of processor devices includes a plurality of ports, and each of first processor devices included in a first processor device-memory device group of the plurality of processor device-memory device groups is connected to a first subset of one of first switches of the plurality of switches included in the first processor device-memory device group and to a first subset of ports of one switch of second switches of the plurality of switches included in a second processor device-memory device group of the plurality of processor device-memory device groups.

In another one or more general aspects, an electronic apparatus includes a plurality of memory device groups, and each of the plurality of memory device groups includes a plurality of memory devices, respectively comprising one or memories, and a plurality of switches. Each of the plurality of memory devices includes a plurality of ports. Each of first included in a first memory device group of the plurality of memory device groups is connected to a first subset of ports of one switch of first switches included in the first memory device group, and to a first subset of ports of one switch of second switches of the plurality of switches included in a second processor device-memory device group of the plurality of processor device-memory device groups.

The first memory devices may be connected to a first switch of the first switches and a first switch of the second switches.

In another one or more general aspects, an electronic apparatus includes a plurality of processor device groups, and each of the plurality of processor device groups includes a plurality of processor devices, respectively comprising one or processors, and a plurality of switches. Each of the plurality of processor devices includes a plurality of ports, and each of first processor devices included in a first processor device group of the plurality of processor device groups is connected to a first subset of one of first switches of the plurality of switches included in the first processor device group, and to a first subset of one switch of second switches of the plurality of switches included in a second processor device of the plurality of processor device groups.

In another one or more general aspects, an electronic apparatus includes a plurality of processor device-memory device groups, and each of the plurality of processor device-memory device groups includes a plurality of memory devices respectively comprising one or more memories, a plurality of processor devices respectively comprising one or more processors, and a plurality of switches. Each of the plurality of switches includes a plurality of ports. The plurality of memory devices in one processor device-memory device group of the plurality of processor device-memory device groups is connected to first subsets of ports of each of the plurality of switches in the one processor device-memory device group and another one processor device-memory device group of the plurality of processor device-memory device groups.

The plurality of memory devices in the other one processor device-memory device group may be connected to second subsets of ports of each of the plurality of switches in the other one processor device-memory device group and a third processor device-memory device group of the plurality of processor device-memory device groups.

The plurality of processor devices in the one processor device-memory device group may be connected to third subsets of ports of each of the plurality of switches in the one processor device-memory device group and the other one processor device-memory device group.

Each of the plurality of processor device-memory device groups may further include a plurality of network device connected to fourth subsets of ports of each of the plurality of switches in the one processor device-memory device group.

The electronic apparatus may be a storage device.

Other features and aspects will be apparent from the following detailed description, the drawings, and the claims.

### BRIEF DESCRIPTION OF THE DRAWINGS

FIGS. 1 to 3 illustrate examples of a concatenation structure between a switch and a device, according to one or more embodiments.

FIGS. 4 to 7 illustrate examples of a connection structure between a multi-port device and a device, according to one or more embodiments.

FIGS. 8 to 16 illustrate examples of a connection structure of an electronic apparatus, according to one or more embodiments.

FIGS. 17 and 20 illustrate examples of implementing an electronic apparatus, according to one or more embodiments.

FIGS. 21 to 27 illustrate examples of implementing an electronic apparatus, according to one or more embodiments.

Throughout the drawings and the detailed description, unless otherwise described or provided, the same drawing reference numerals may be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. The use of the term “may” herein with respect to an example or embodiment, e.g., as to what an example or embodiment may include or implement, means that at least one example or embodiment exists where such a feature is included or implemented, while all examples are not limited thereto.

Throughout the specification, when a component or element is described as being “on”, “connected to,” “coupled to,” or “joined to” another component, element, or layer it may be directly (e.g., in contact with the other component or element) “on”, “connected to,” “coupled to,” or “joined to” the other component, element, or layer or there may reasonably be one or more other components, elements, layers intervening therebetween. When a component or element is described as being “directly on”, “directly connected to,” “directly coupled to,” or “directly joined” to another component or element, there can be no other elements intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C” and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

Unless otherwise defined, all terms, including technical and scientific terms, used herein have the same meaning as commonly understood by one of ordinary skill in the art to which this disclosure pertains specifically in the context on an understanding of the disclosure of the present application. Terms, such as those defined in commonly used dictionaries, are to be interpreted as having a meaning that is consistent with their meaning in the context of the relevant art and specifically in the context of the disclosure of the present application, and are not to be interpreted in an idealized or overly formal sense unless expressly so defined herein.

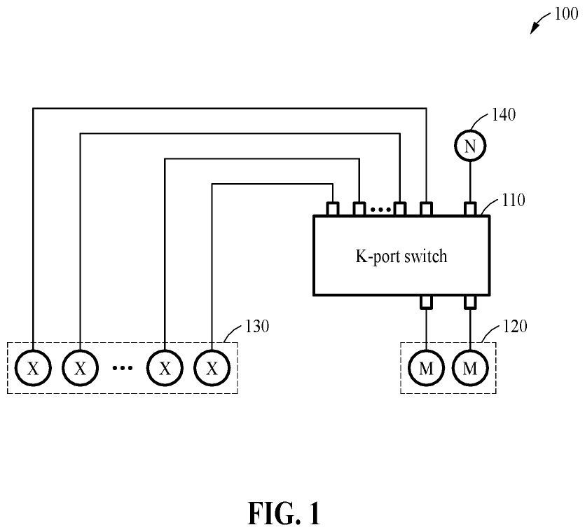

FIGS. 1 to 3 illustrate examples of a connection structure between switches and another device, according to one or more embodiments.

So it is found that an efficient management technique for the high-density computing resources is desired to improve a rack-scale computing infrastructure, a disaggregated memory pool may be configured in units of racks using a compute express link (CXL). The disaggregated memory pool may be implemented as a memory box using a CXL switch. When the CXL switch is used, the connection between devices, e.g., switch, memory device, processor device, network device, etc., included in an electronic apparatus 100 may be reconstructed. The memory box may also be referred to as a storage device in the examples disclosed herein. Additionally, each of the switch, memory device, processor device, and network device may also individually, or as any combination thereof, be considered electronic apparatuses.

Referring to FIG. 1, an electronic apparatus 100 may include a switch 110, a memory device 120, a processor device 130, and a network device 140. In an example, the memory device 120, the processor device 130, and the network device 140 may be connected to each other through the switch 110. With respect to FIG. 1, the illustrated memory device 120 is representative of multiple memory devices 120 with corresponding connections as discussed herein, the processor device 130 is representative of multiple processor devices 130 with corresponding connections as discussed herein, and network device 140 is representative of multiple processor devices 130 with corresponding connections as discussed herein, and thus, the respective references to the memory device 120, the processor device 130, and the network device 140 are merely for the convenience of description, and examples are not limited to thereto. Each of the processor devices 130 may be an xPU device, such as a central processing unit (CPU), a graphics processing unit (GPU), and a neural processing unit (NPU) that performs operations specialized for artificial intelligence (AI), etc., where each of the xPU devices may themselves include multiple processors or processor cores.

The switch 110 may be configured to connect devices (e.g., the memory device 120, the processor device 130, the network device 140, etc.) included in the electronic apparatus 100 to each other. The switch 110 may include K-ports corresponding to links composed of L lanes. The total number of lanes M of the switch 110 may be determined as L×K. In a non-limiting example, in examples where M=144 and M=256, a 144-lane switch may include 18 ports based on 8-lane links, and a 256-lane switch may include 32 ports based on 8-lane links, for example. Specific numerical values of M, K, and L are not limited to the above example, and for the convenience of description, the operation of the electronic apparatus 100 will be described based on examples of where M=144, L=8, and K=16.

The memory device 120 is a device capable of storing data and/or signals, and may include a non-volatile memory device (e.g., a solid-state drive (SSD), etc.) and/or a volatile memory (e.g., a dynamic random-access memory (DRAM), etc.). For example, the memory device 120 may be a CXL memory device to, and from, which data is input and/or output according to the CXL, but is not limited to the above example.

The processor device 130 is a device capable of performing operations, and may include various computing resources, for example, a central processing unit (CPU) that performs general-purpose operations, a graphics processing unit (GPU) that performs operations specific to image processing, and a neural processing unit (NPU) that performs operations specific to artificial intelligence (AI), and the like.

The network device 140 is a device for communicating between electronic devices on a computer network to mediate data transmission, e.g., an external device of the electronic apparatus 100. The network device 140 may include, for example, a network interface controller (NIC). For example, the network device 140 may be connected to a global network as an external expandable network, a storage network expandable as a storage, and a management network expandable for management purposes.

In the example of FIG. 1, the switch 110 may be connected to 2 memory devices 120, 15 processor devices 130, and a network device 140 through 18 ports. In a non-limiting example, the switch 110 may have 1 uplink and 17 downlinks. In an example of a CXL protocol where the maximum capability of multiple logical devices (MLD) proposed in a CXL protocol is 16, connecting 1 memory device to 16 processor devices may maximize the number of processor devices that can connect to the 1 memory device. However, 15 processor devices 130 and 2 memory devices 120 may be connected to the switch 110, when the processor device connection is configured in multiples of 3 based on the structure of Open Rack v3 by an open compute project (OCP). In an example, the 15 processor devices 130 and the 2 memory devices 120 may be grouped into a processor device-memory device group.

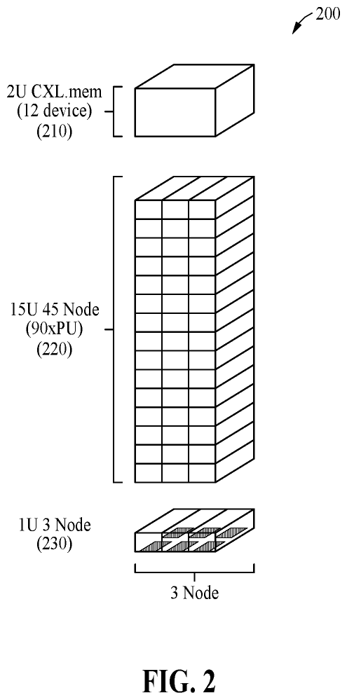

FIG. 2 depicts an example of an electronic apparatus 200 in which the processor device-memory device group includes the 15 processor devices and the 2 memory devices expanded to a rack size. The electronic apparatus 200 may have a 1 U 3 Node structure 230, including a memory box 210 with a size of 2 U that includes 12 memory devices, and a processor box 220 of 45 nodes with a size of 15 U and including a total of 90 processing devices. In the example of FIG. 2, the electronic apparatus 200 may connect the total of 90 processor devices in a 17 U scale (i.e., through the 15 U of the processor box 220), but the number of connectable memory devices per processor device is fixed at 2, and the number of connectable processor devices per memory device is fixed at 15. The 1 U 3 Node structure 230, demonstrates a 1 U configuration of each of the 15 U of the processor box 220, with two shaded boxes included in each of the three nodes representing a total of 6 processor devices (i.e., with two processor devices being mounted per node). In other words, the electronic apparatus 200 may include a total of 6 switches and 90 processor devices. In the examples, the processor box may also be referred to as, or included in, an operation device.

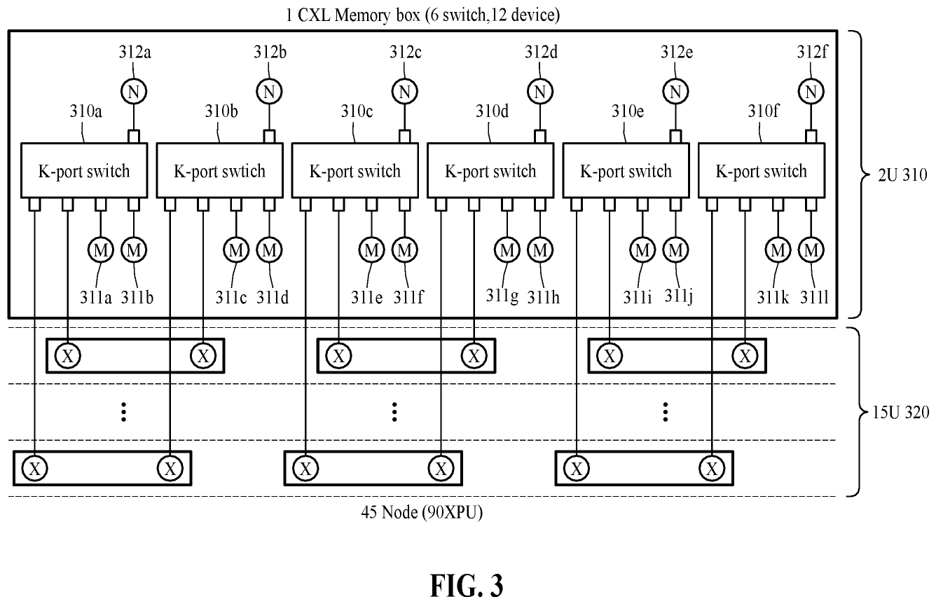

In the example of FIG. 3, a memory box 310 may include a total of 6 switches 310a-310f and 12 memory devices 311a-311l, and may be connectable up to 90 processor devices 320. However, in the example, the number of connectable memory devices per processor device may still be fixed at 2, and the number of connectable processor device per memory box may still be fixed at 15. Hereinafter, a structure capable of effectively increasing the number of connectable memory devices per processor device and the number of connectable processor devices per memory device will be described in further detail.

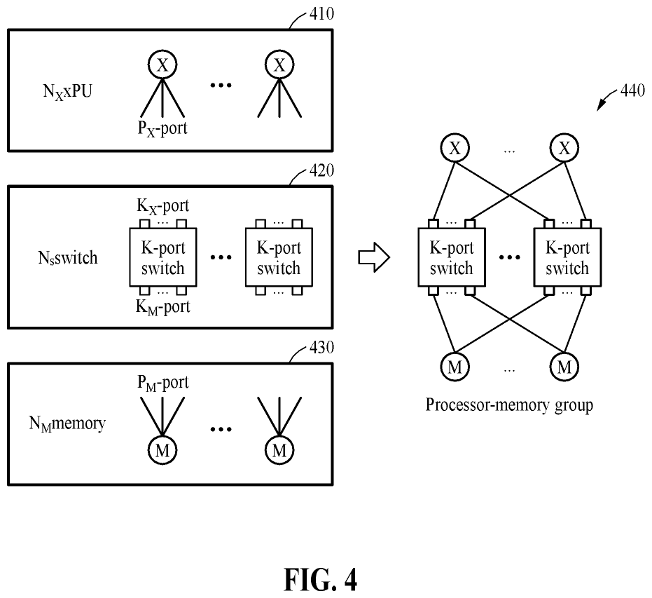

FIGS. 4 to 7 illustrate examples of a connection structure between a multi-port device and a device, according to one or more embodiments.

In the example of FIG. 4, a processor device-memory device group 440 may include a plurality of processor devices 410, a plurality of switches 420, and a plurality of memory devices 430.

Each of the plurality of processor devices 410 may have P_{X} ports. When the number of ports P_{X} is 2 or more, each of the plurality of processor devices 410 includes a multi-port. The number of the plurality of processor devices 410 may be expressed as N_{X}, where N is a positive integer. The xPU shown in FIG. 4 may represent one or more processors or processor cores, as discussed above.

Each of the plurality of switches 420 may have K ports, satisfying K=K_{X}+K_{M}, where K_{X} represents a switch port connected to the processor device, and K_{M} represents a switch port connected to the memory device. Each of the plurality of switches 420 may be, or included in, a CXL switch. Each of the plurality of switches 420 may be, or included in, a single-stage switch. The number of the plurality of switches 420 may be expressed as N_{S}.

Each of the plurality of memory devices 430 may have P_{M} ports. When the number of P_{M} ports is 2 or more, each of the plurality of memory devices 430 may include a multi-port. Therefore, the number of the plurality of memory devices 430 may be expressed as N_{M}.

A memory box structure for maximizing a rack-scale high-density computing resource performance will be described in further detail in the examples based on a single-port processor device-multi-port memory device, a multi-port processor device-single-port memory device, or a multi-port processor device-multi-port memory device.

Due to a limitation in the number of devices connectable to a switch having K ports being K, an increase in a memory device expansion gain of a processor device may cause a decrease in a multi-user gain of a memory device, and an increase in a multi-user gain of a memory device may cause a decrease in a memory device expansion gain of a processor device. The memory device expansion gain of the processor device and the multi-user gain of the memory device may be effectively improved by utilizing a multi-port device (e.g., a multi-port memory device and/or a multi-port processor device). Here, a memory device expansion gain may indicate the number of devices to which one processor device may be connected, and a multi-user gain may be a multiple access gain or a multiplexing gain, and may indicate the number of devices that one memory device may accommodate.

When a processor device-memory device group (e.g., processor device-memory device group 440), including a multi-port device (e.g., a multi-port memory device and/or a multi-port processor device), is formed, the connection is physically possible only when sufficient ports are available for the processor device-switch-memory device connection.

For example, the minimum requirements for the physical connection of processor device-switch-memory device may be as below, where N_{X} represents the number of processor devices, N_{S} represents the number of switches, N_{M} represents the number of memory devices, P_{X} represents the number of processor device ports, K represents the number of switch ports, and K_{X} represents the number of ports allocated to a processor device among the switch ports, K_{M} represents the number of ports allocated to memory devices among the switch ports, and P_{M} represents the number of memory device ports.

The total number of ports for the plurality of processor devices 410 in the processor device-memory device group 440 may meet N_{X}×P_{X}<N_{S}×K_{X}.

The total number of ports for the plurality of switches 420 in the processor device-memory device group 440 may meet K_{X}+K_{M}<K.

The total number of ports for the plurality of memory devices 430 in the processor device-memory device group 440 may meet N_{M}×P_{M}<N_{S}×K_{M}.

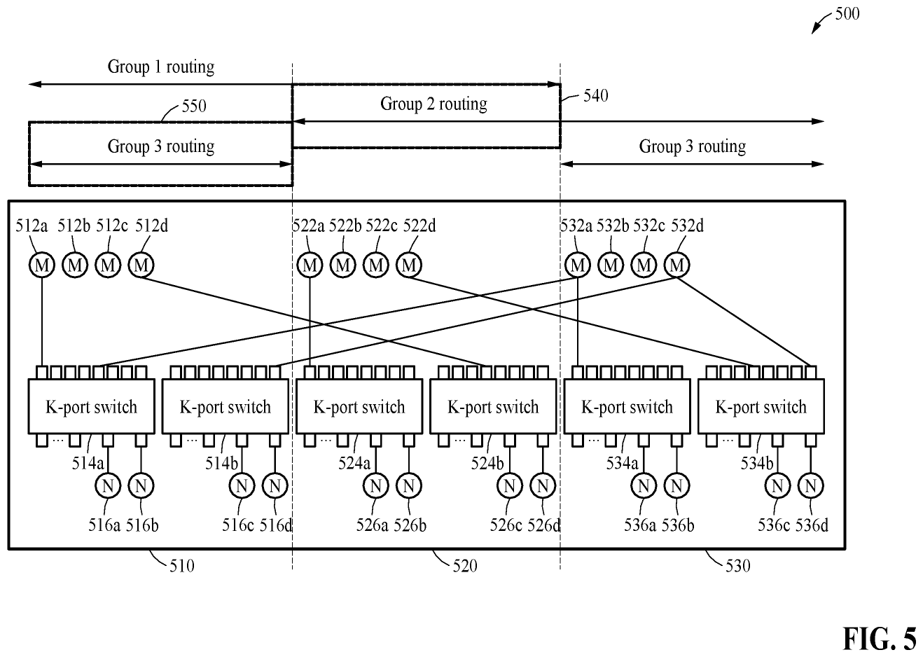

In FIG. 5, an electronic apparatus 500 may include a total of 6 switches 514a, 514b, 524a, 524b, 534a, 534b, 12 memory devices 512a-d, 522a-d, 532a-d, 48 processor devices, and 12 network devices 516a-d, 526a-d, 536a-d. In the non-limiting example of FIG. 5, each of the 12 memory devices 512a-d, 522a-d, 532a-d may include 4 ports, each of the 6 switches 514a, 514b, 524a, 524b, 534a, 534b may include 18 ports, and each processor device and network device may include a single port. For the convenience of description with reference to FIG. 5, the description of processor devices and the connection between the memory devices and the switches may be partially or fully omitted. The number of switches 514a, 514b, 524a, 524b, 534a, 534b, memory devices 512a-d, 522a-d, 532a-d, processor devices, and network devices 516a-d, 526a-d, 536a-d shown in FIG. 5 is for convenience of description, and is not limited to the above example.

The electronic apparatus 500 may be grouped into different processor device-memory device groups, e.g., processor device-memory device group 1 510, processor device-memory device group 2 520, and processor device-memory device group 3 530, and each of the processor device-memory device groups 510-530 may include 2 switches of the switches 514a, 514b, 524a, 524b, 534a, 534b, 4 memory devices of the memory devices 512a-d, 522a-d, 532a-d, and 16 processor devices of the 48 processor devices.

For example, the size of a processor device-memory device group configured with NS K-port switches may be determined using Expression 1.

$${N}_{S} \times ( {K}_{X} + {K}_{M} ) \leq {N}_{S} \times K \qquad Expression 1$$

Using Expression 1 above, Expression 2 may be used to determine the number of processor devices N_{X}.

$${N}_{X} \times {P}_{X} + {N}_{M} \times {P}_{M} \leq {N}_{S} \times ( {K}_{X} + {K}_{M} ) \leq {N}_{S} \times K \qquad Expression 2$$

$${N}_{X} \leq ( {N}_{S} \times K - {N}_{M} \times {P}_{M} ) / {P}_{X}$$

In a case where P_{M}=1 and P_{X}=1, e.g., in the case of the “single-port memory device-single-port processor device,” N_{X} becomes maximum, and Expression 3 below may be derived. In this case, the number of processor devices N_{X} may be a multiple of a predetermined number. For example, according to the Open Rack v3 structure, a condition in which the number of processor devices N_{X} is a multiple of 3 may be applied to Expression 2 to derive Expression 3.

$${N}_{X} \leq ( {N}_{S} \times K - {N}_{M} ) \qquad Expression 3$$

In a case where P_{M}>1, P_{X}=1, e.g., in the case of the “multi-port memory device-single-port processor device,” N_{X} is reduced to a form of subtraction as in Expression 4 below.

$${N}_{X} \leq ( {N}_{S} \times K - {N}_{M} \times {P}_{M} ) \qquad Expression 4$$

In contrast, in the case of P_{M}=1, P_{X}>1, e.g., in the case of the “single-port memory device-multi-port processor device,” N_{X} is reduced to a form of division as in Expression 5 below.

$${N}_{X} \leq ( {N}_{S} \times K - {N}_{M} ) / {P}_{X} \qquad Expression 5$$

In summary, a “multi-port-memory device-single-port processor device” may be advantageous in maintaining a large scale of computing resources that may be shared per memory device, when compared to a “single-port memory device-multi-port processor device.” Therefore, the electronic apparatus 500 may be configured to maximize a rack-scale high-density computing resource performance when it is possible to provide both a memory device expansion gain of a processor device and a multi-user gain of a memory device.

A routing method for the processor device-switch-memory device connection may be readily determined when the numbers of the switches, memory devices, processor devices, and network devices included in the electronic apparatus 500 are known or determined. The routing method may be reflected in a memory device box structure based on resource granularity that affects routing complexity, and path diversity that affects the memory device expansion gain and the multi-user gain.

In order to effectively connect a predetermined number of multi-port devices (e.g., the multi-port memory device and/or multi-port processor device) to a predetermined number of K-port switches, there may be a partially overlapping routing path between the processor device-memory device groups and a routing path wrapped around on an edge of the memory box. The routing path in a processor device-memory device group may be determined so that the memory device and the processor device in the processor device-memory device group are effectively load-balanced for the switch.

In the example of FIG. 5, a partial overlap may occur between adjacent processor device-memory device groups, such as between the processor device-memory device group 1 (510) and the processor device-memory device group 2 (520), and between the processor device-memory device group 2 (520) and the processor device-memory device group 3 (530). For example, a partial overlap 540 may occur in the processor device-memory device group 2 (520) that is physically most adjacent to the processor device-memory device group 1 (530) based on the processor device-memory device group 1 (530).

The processor device-memory device group 1 (510) and the processor device-memory device group 3 (530) may be logically adjacent to each other, even though not physically most adjacent to each other, and a wrap-around routing path may occur between the two processor device-memory device groups. For example, a wrap-around routing path 550 may occur in the processor device-memory device group 1 (510) that is not physically most adjacent to, but is logically adjacent to, the processor device-memory device group 3 (530) based on the processor device-memory device group 3 (530). The processor device-memory device group 1 (510) and the processor device-memory device group 3 (530) may be processor device-memory device groups disposed at outer edges of the electronic apparatus 500. In an example, a condition may exist where the processor device-memory device groups connected by the wrap-around routing path need to be disposed within a physical distance to transmit an electrical signal.

Through the connection between other processor device-memory device groups, in addition to the connection in the same processor device-memory device group based on the routing paths described above, both the memory device expansion gain of the processor device and the multi-user gain of the memory device may be attained. A traffic distribution efficiency between switches may also be attained through the duplicated multiple routing paths.

Assuming there is no restriction on a physical reach distance of the electrical wiring within the electronic apparatus 500, a total of 6 switches may be used to connect a total of 12 memory devices in one memory box, and the switches and memory devices may be grouped into a total of 3 processor device-memory device groups.

According to another embodiment, any one of an ordered group routing, stochastic routing, and round-robin routing may be applied in addition to the routing method described above. The ordered group routing is a routing technique where regular ordered routing connections are made to adjust the resource granularity and make resource partitioning easier, which may result in low implementation complexity. The stochastic routing is a routing technique where irregular routing connections are made for easier load balancing to efficiently distribute system performance limits by maximizing the path diversity, which may lead to a relatively high implementation complexity. The round-robin routing is a routing technique where sequential routing connections are made to limit the routing complexity and ensure the load balancing like the stochastic routing, which may lead to a relatively low implementation complexity and balanced distribution effect.

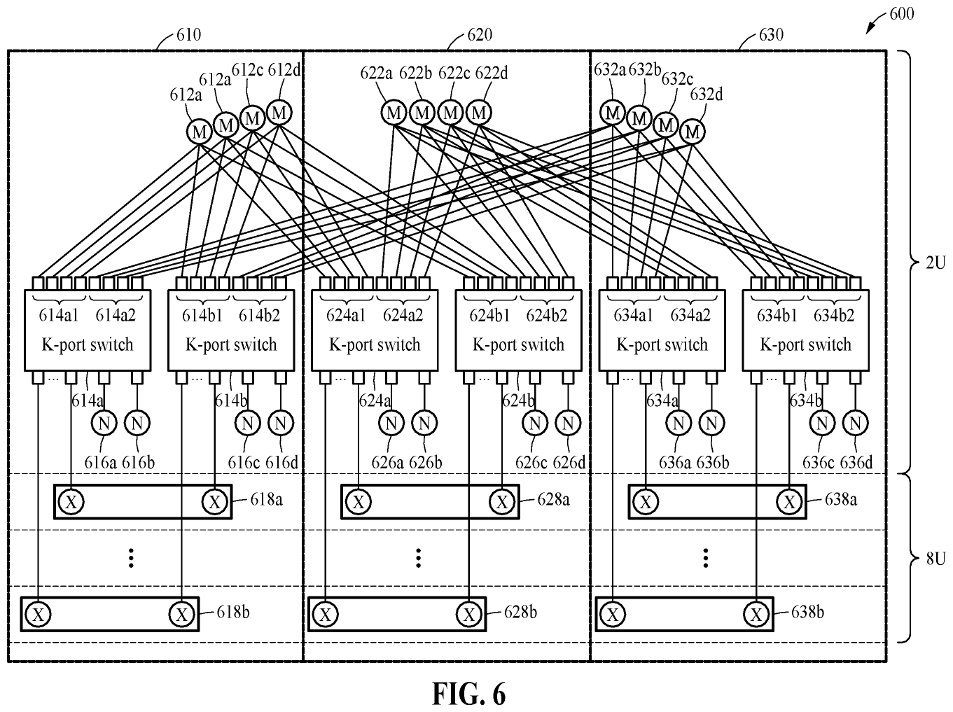

In FIG. 6, an electronic apparatus 600 may include a total 6 switches 614a, 614b, 624a, 624b, 634a, 634b, 12 memory devices 612a-d, 622a-d, 632a-d, 48 processor devices 618a-r, 628a-r, 636a-r, and 12 network devices 616a-d, 626a-d, 636a-d. In an example of FIG. 6, each of the memory devices 612a-d, 622a-d, 632a-d may include 4 ports, each of the switches 614a, 614b, 624a, 624b, 634a, 634b may include 18 ports, and each of the processor devices 618a-r, 628a-r, 636a-r and the network devices 616a-d, 626a-d, 636a-d may include a single port. The routing paths depicted in FIG. 6 between the switches 614a, 614b, 624a, 624b, 634a, 634b, the memory devices 612a-d, 622a-d, 632a-d, and the network devices 616a-d, 626a-d, 636a-d may be determined based on the routing method described above with reference to FIG. 5. The switches 614a, 614b, 624a, 624b, 634a, 634b, the memory devices 612a-d, 622a-d, 632a-d, the processor devices 618a-r, 628a-r, 636a-r, and the network devices 616a-d, 626a-d, 636a-d included in the electronic apparatus 600 may be grouped into three processor device-memory device groups 610 to 630. For the convenience of description with reference to FIG. 6, some of the processor devices may be omitted, and the numbers of the switches 614a, 614b, 624a, 624b, 634a, 634b, the memory devices 612a-d, 622a-d, 632a-d, the processor devices 618a-r, 628a-r, 636a-r, and the network devices 616a-d, 626a-d, 636a-d shown in FIG. 6 are merely for ease of description and are not limited to the above example.

The electronic apparatus 600 has a 1 U 3 Node structure and may be a 10 U-scale rack, including a 2 U memory box and an 8 U processor box. The 2 U memory box may include 12 memory devices (e.g., memory devices 612a-d, 622a-d, 632a-d), and the 8 U processor box may include 48 processor devices (e.g., processor devices 618a-r, 628a-r, 636a-r).

The memory devices (e.g., memory devices 612a-d) in the same processor device-memory device group may be equally connected to the switches (e.g., switches 614a, 614b) in the same processor device-memory device group (e.g. processor device-memory device group 610). For example, each of the first memory devices (e.g., memory devices 612a-d) included in the processor device-memory device group 1 (610) may be connected to all of the first switches (e.g., switches 614a, 614b) included in the processor device-memory device group 1 (610). Two ports (e.g., ports 614a1, 614a2) of the four ports 614a1, 614a2, 614b1, 614b2 of each of the first memory devices (e.g., memory devices 612a-d) may be connected to the first switches (e.g., switches 614a, 614b) included in the processor device-memory device group 1 (610), and the remaining two ports (e.g., ports 614b1, 614b2) may be used for a partial overlap routing path. In other words, the remaining two ports (e.g., ports 614b1, 614b2) may be equally connected to the second switches 624a, 624b of the adjacent processor device-memory device group 2 (620). For the partial overlap routing, the first memory devices 612a-612d may be connected to some of the remaining switches 624a, 624b, 634a, 634b other than the first switches 614a, 614b. Two ports (e.g., ports 634a1, 634b1) of the four ports 634a1, 634a2, 634b1, 634b2 of each of the third memory devices (e.g., memory devices 632a-d) of the processor device-memory device group 3 (630) may be connected to third switches 634a, 634b included in the processor device-memory device group 3 (630), and the remaining two ports (e.g., ports 634a2, 634b2) may be used for the wrap-around routing path. In other words, the remaining two ports (e.g., ports 634a2, 634b2) may be equally connected to the first switches 614a, 614b of the processor device-memory device group 1 (610), which is not physically most adjacent but logically adjacent.

The switches (e.g., switches 614a, 614b) in the same processor device-memory device group (e.g., processor device-memory device group 610) may be equally connected to the memory devices (e.g., memory devices 612a-d) in the same processor device-memory device group. For example, each of the first switches 614a, 614b included in the processor device-memory device group 1 (610) may be connected to all of the first memory devices 612a-d included in the processor device-memory device group 1 (610).

In an example where the processor device and the network device have a single port, the processor device and the network device may be connected to the switches in the same processor device-memory device group. At least some of the remaining ports not connected to the memory device, among the plurality of ports included in each of the plurality of switches, may be connected to the processor device included in the same processor device-memory device group.

The switch may be used to connect the memory device and the processor device. The switches may not be connected to each other, but may be used for management purposes when connecting the switches. In other words, signals for the management purposes may be transmitted and received through the connection between the switches. For example, the switch may be a CXL switch.

The number of memory devices (e.g., memory devices 612a-d, 622a-d, or 632a-d) included in each of the processor device-memory device groups 610 to 630 may be the same. The number of switches (e.g., switches 614a, 614b, 624a, 624b, 634a, or 634b) included in each of the processor device-memory device groups 610 to 630 may be the same. The number of processor devices (e.g., processor devices 618a-r, 628a-r, or 636a-r) included in each of the processor device-memory device groups 610 to 630 may be the same.

In the example of FIG. 6, the electronic apparatus 600 may include 12 quad-port CXL memory devices (e.g., memory devices 612a-d, 622a-d, 632a-d), 48 processor devices (e.g., processor devices 618a-r, 628a-r, 636a-r), and 12 network devices (e.g., network devices 616a-d, 626a-d, 636a-d). Assuming that the CXL memory device has a storage capacity of 512 gigabytes (GB), a total of 6 terabytes (TB) may be provided with a 2 U memory box, and the connection with respect to a total of 48 processor devices with a size of 10 U may be possible as the high-density computing resource scale. The memory device expansion gain may allow access to 8 memory devices per processor device, and the multiple access gain may allow access to 32 processor devices per memory device.

In the example of FIG. 6, the routing paths between the memory devices 612a-d, 622a-d, 632a-d and the switches 614a, 614b, 624a, 624b, 634a, 634b with multi-ports may be slightly complicated, whereas the routing paths between the processor devices 618a-r, 628a-r, 636a-r and the switches 614a, 614b, 624a, 624b, 634a, 634b with a single port may be relatively simple. Based on such a connection structure characteristic, the plurality of processor devices 618a-r, 628a-r, 636a-r may be simply connected to the memory box, including the plurality of memory devices 612a-d, 622a-d, 632a-d and the plurality of switches 614a, 614b, 624a, 624b, 634a, 634b connected as shown in FIG. 6, thereby easily providing the rack-scale electronic apparatus 600.

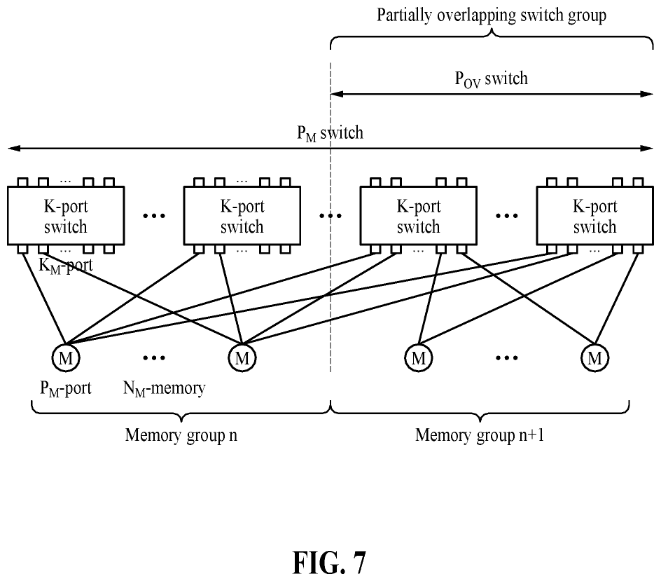

FIG. 7 shows an example for describing a partially overlapping routing path between processor device-memory device groups. A memory device group n, including N_{M} memory devices having P_{M} ports, may be connected to P_{M} switches. If Pₒᵥ switches overlapping with an adjacent memory device group n+1 on a path are allowed, the number of switches desired to connect a total of N_{M,group} memory device groups may be minimized based on a condition N_{M,group}×N_{M}×P_{M}<N_{S}×K_{M} in consideration of the partial overlap and the wrap-around routing path.

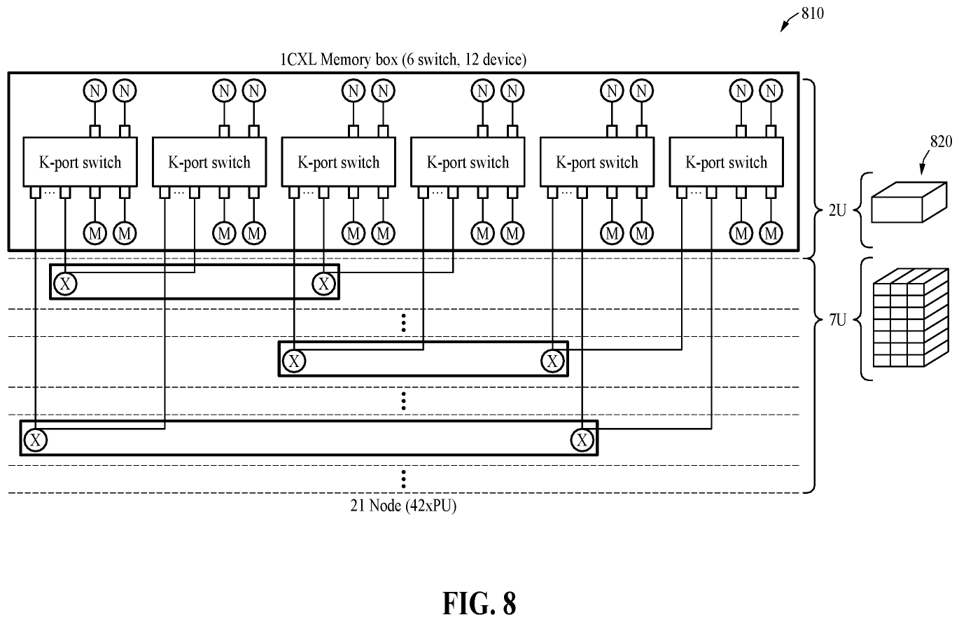

FIGS. 8 to 16 illustrate examples of a connection structure of an electronic apparatus, according to one or more embodiments.

FIG. 8 shows a connection structure 810 and a rack 820 of an electronic apparatus in a case of a “dual-port processor device, a single-port memory device.” For the convenience of description with reference to FIG. 8, some of the 42 processor devices may be omitted, and the numbers of switches, memory devices, processor devices, and network devices shown in FIG. 8 are merely for ease of description and are not limited to the above example.

The electronic apparatus may be configured as a 9 U-scale rack, including a 2 U memory box and a 7 U processor box. The electronic apparatus may connect 42 processor devices with a scale of 9 U and may allow access to 4 memory devices per processor device, thereby increasing expandable memory device capacity per processor device.

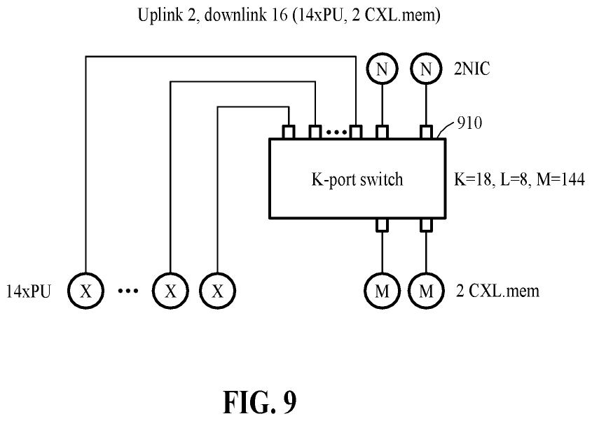

In FIG. 9, in a case of the “dual-port processor device, the single-port memory device” described above with reference to FIG. 8, 14 processor devices, 2 memory devices, and 2 network devices may be connected to a switch 910. The switch may include 18 ports composed of 8 lanes, and may have a total of 144 lanes.

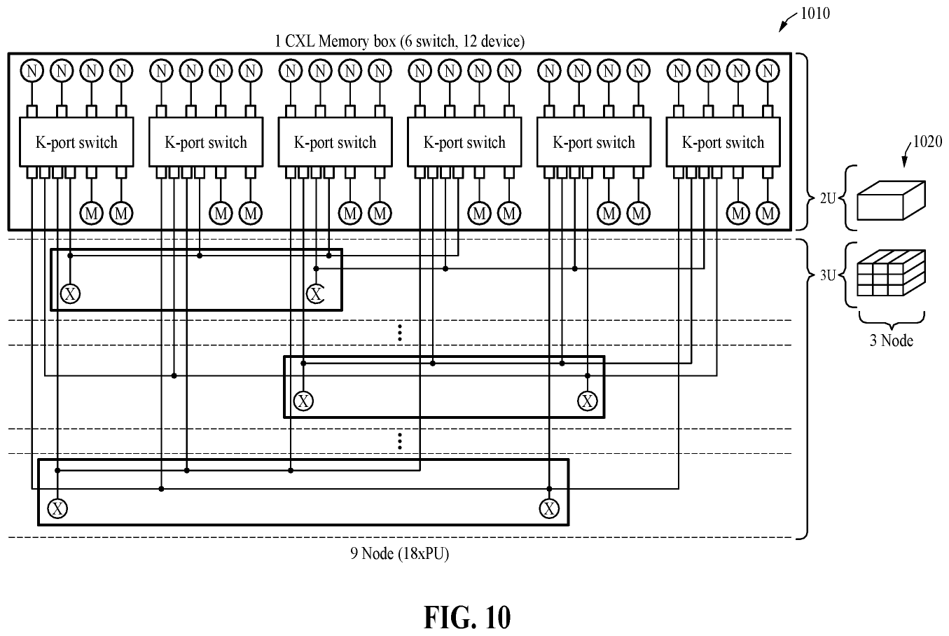

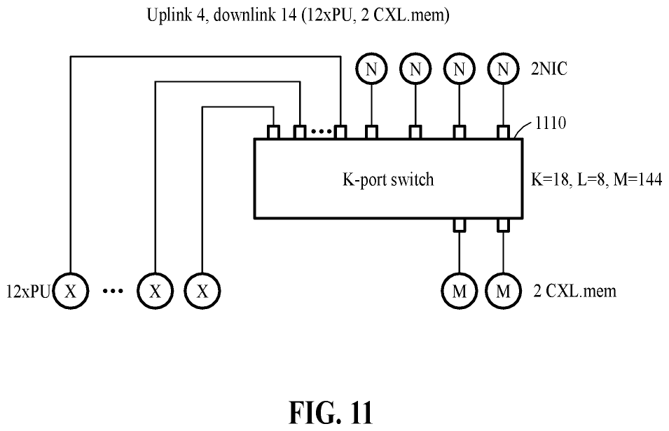

FIG. 10 shows a connection structure 1010 and a rack 1020 of an electronic apparatus in a case of a “quad-port processor device, a single-port memory device.” For the convenience of description with reference to FIG. 10, some of the 18 processor devices may be omitted, and the numbers of switches, memory devices, processor devices, and network devices shown in FIG. 10 are merely for ease of description and are not limited to the above example.

The electronic apparatus may be configured as a 5 U-scale rack, including a 2 U memory box and a 3 U processor box. The electronic apparatus may connect 18 processor devices with a scale of 5 U and may allow access to 8 memory devices per processor device, thereby increasing expandable memory device capacity per processor device. However, the rack-scale high-density computing resources may be reduced due to tradeoffs.

Referring to FIG. 11, in the case of the “quad-port processor device, the single-port memory device” described above with reference to FIG. 10, 12 processor devices, 2 memory devices, and 2 network devices may be connected to a switch 1110. The switch may include 18 ports composed of 8 lanes, and may have a total of 144 lanes.

When an electronic apparatus is configured with a single-port processor device, a dual-port processor device, or a quad-port processor device based on a single-port memory device, the rack scale and access coverage may be as shown in Table 1 below.

TABLE 1

| Processor device, | Rack | Access coverage |
|---|---|---|
| Single-port | 12 Memory devices | 2 Memory |
| | 90 Processor devices | devices/processor device |
| | 6 Network devices | 15 Processor |
| | | devices/memory device |
| Dual-port | 12 Memory devices | 4 Memory |
| | 42 Processor devices | devices/processor device |
| | 12 Network devices | 14 Processor |
| | | devices/memory device |
| Quad-port | 12 Memory devices | 8 Memory |
| | 18 Processor devices | devices/processor device |
| | 24 Network devices | 12 Processor |
| | | devices/memory device |

As the number of the ports of the processor device increases, the number of accessible memory devices per processor device increases. While one memory device may be shared and used by many processor devices, rack-scale high-density computing resources may rapidly reduce. As the number of the ports of the processor device increases, the number of accessible processor devices per memory device may reduce.

A relationship where the computing resource scale reduce as the number of the ports of the processor device increases may be the same as Expression 5.

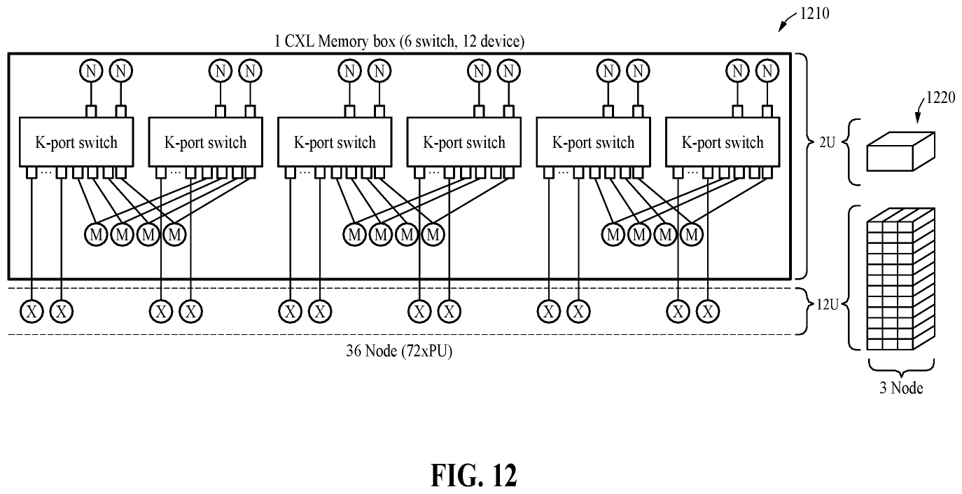

FIG. 12 shows a connection structure 1210 and a rack 1220 of an electronic apparatus in a case of a “single-port processor device, a dual-port memory device.” For the convenience of description with reference to FIG. 12, some of 72 processor devices may be omitted, and the numbers of switches, memory devices, processor devices, and network devices shown in FIG. 12 are merely for ease of description and are not limited to the above example.

The electronic apparatus may be configured as a 14 U-scale rack, including a 2 U memory box and a 12 U processor device box. The electronic apparatus may connect 72 processor devices with a scale of 14 U and may allow access to 4 memory devices per processor device, thereby increasing expandable memory device capacity per processor device. Also, it may allow access to 24 processor devices per memory device, and thus, the multi-user gain of the memory device may increase.

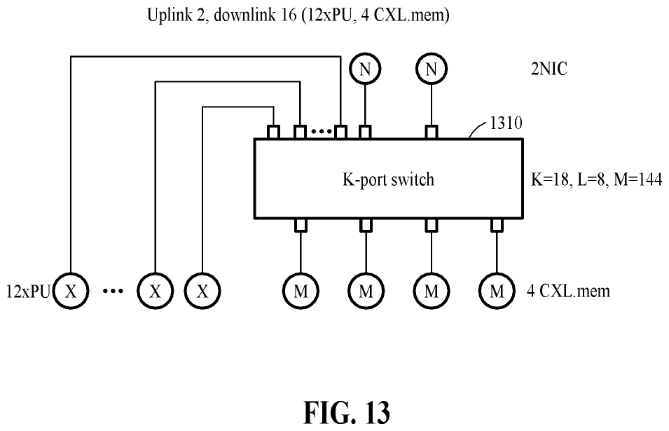

Referring to FIG. 13, in the case of the “single-port processor device, the dual-port memory device” described above with reference to FIG. 12, 12 processor devices, 4 memory devices, and 2 network devices may be connected to a switch 1310. The switch may include 18 ports composed of 8 lanes and a total of 144 lanes.

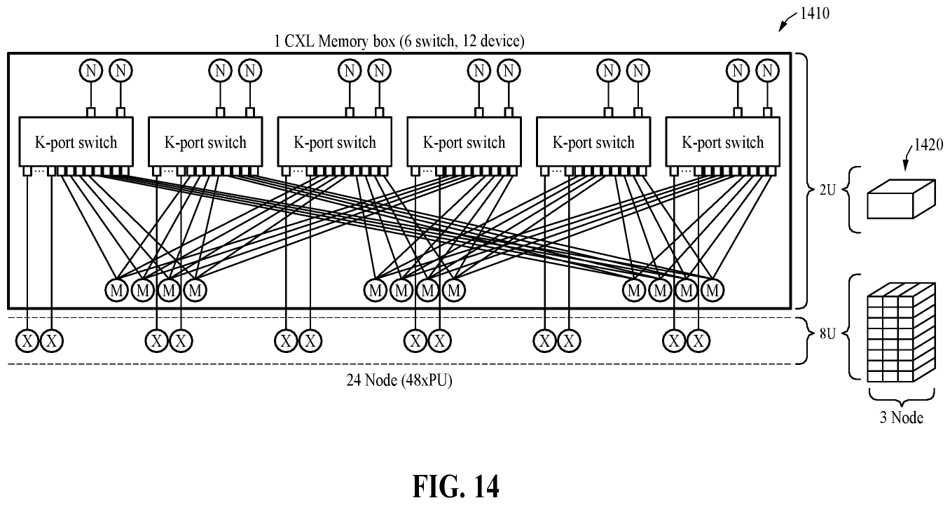

FIG. 14 shows a connection structure 1410 and a rack 1420 of an electronic apparatus in a case of a “single-port processor device, a quad-port memory device.” For the convenience of description with reference to FIG. 14, some of the 48 processor devices may be omitted, and the numbers of switches, memory devices, processor devices, and network devices shown in FIG. 14 are merely for ease of description and are not limited to the above example.

The electronic apparatus may be configured as a 10 U-scale rack, including a 2 U memory box and an 8 U processor box. The electronic apparatus may connect 48 processor devices with a scale of 10 U and allow access to 8 memory devices per processor device, thereby increasing expandable memory device capacity per processor device. Also, it may allow access to 32 processor devices per memory device, and thus, the multi-user gain of the memory device may increase.

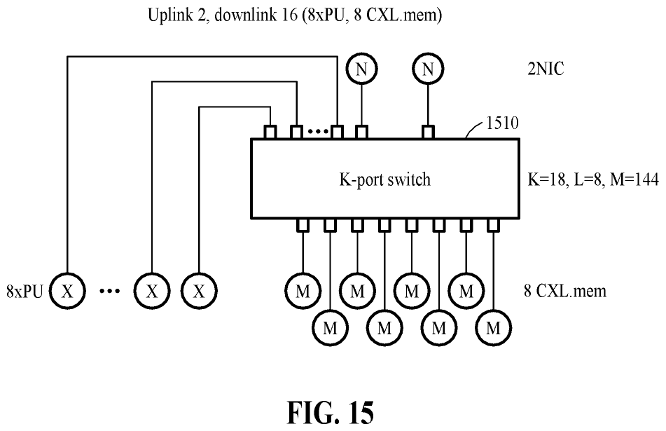

Referring to FIG. 15, in the case of the “single-port processor device, the quad-port memory device” described above with reference to FIG. 13, 8 processor devices, 8 memory devices, and 2 network devices may be connected to a switch 1510. The switch may include 18 ports composed of 8 lanes and a total of 144 lanes.

When an electronic apparatus is configured with a single-port memory device, a dual-port memory device, or a quad-port memory device based on a single-port processor device, the rack scale and access coverage may be as shown in Table 2 below.

TABLE 2

| Memory | Rack | Access coverage |
|---|---|---|
| Single-port | 12 Memory devices | 2 Memory |
| | 90 Processor devices | devices/processor device |
| | 6 Network devices | 15 Processor |
| | | devices/memory device |
| Dual-port | 12 Memory devices | 4 Memory |
| | 72 Processor devices | devices/processor device |
| | 12 Network devices | 24 Processor |
| | | devices/memory device |
| Quad-port | 12 Memory devices | 8 Memory |
| | 48 Processor devices | devices/processor device |
| | 12 Network devices | 32 Processor |
| | | devices/memory device |

As the number of ports of the memory device increases, the number of accessible memory devices per processor device increases. One memory device may be shared and used by many processor devices, but the rack-scale high-density computing resources may be rapidly reduced. As the number of ports of the memory device increases, the number of accessible processor devices per memory device may be reduced.

A relationship that the computing resource scale is reduced as the number of the ports of the memory device increases may be the same as Expression 4.

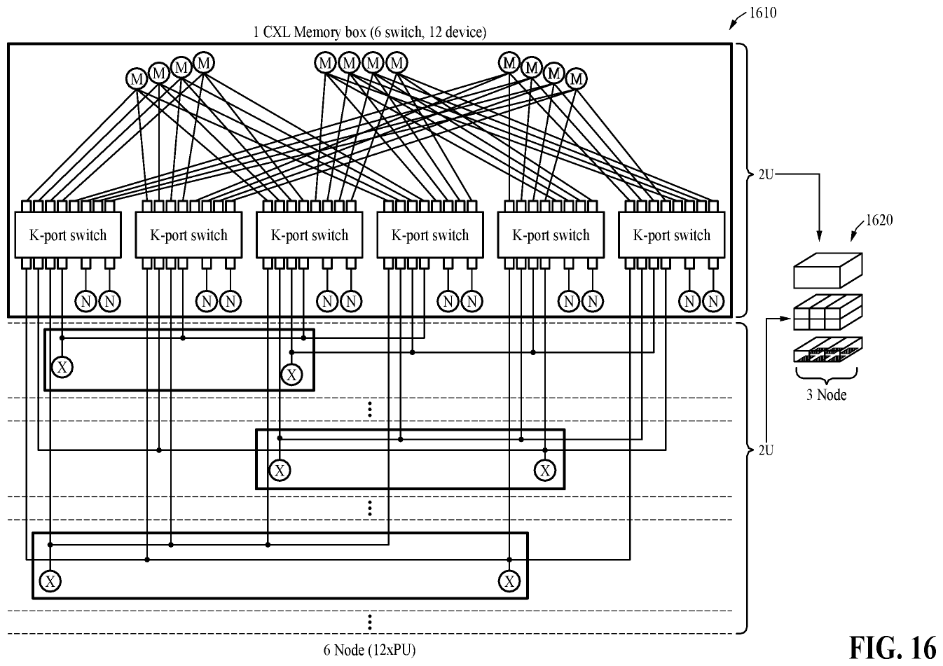

FIG. 16 shows a connection structure 1610 and a rack 1620 of an electronic apparatus in a case of a “quad-port processor device, a quad-port memory device.” For the convenience of description with reference to FIG. 16, some of the 12 processor devices may be omitted, and the numbers of switches, memory devices, processor devices, and network devices shown in FIG. 16 are merely for ease of description and are not limited to the above example.

The electronic apparatus may be configured as a 4 U-scale rack, including a 2 U memory box and a 2 U processor box. The electronic apparatus may connect 12 processor devices with the scale of 4 U, and the number of connectable memory devices per processor device and the number of connectable processor devices per memory device may increase, but the entire operation scale in units of rack may be significantly reduced to the level of 4 U.

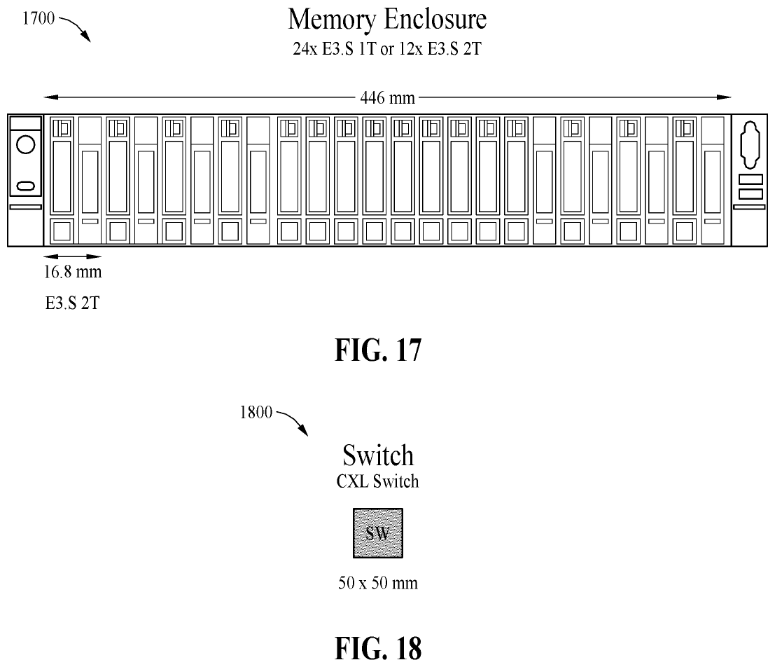

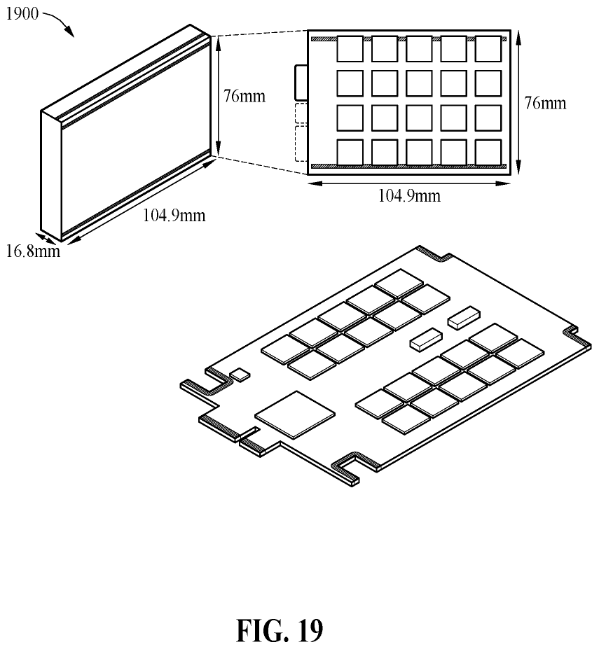

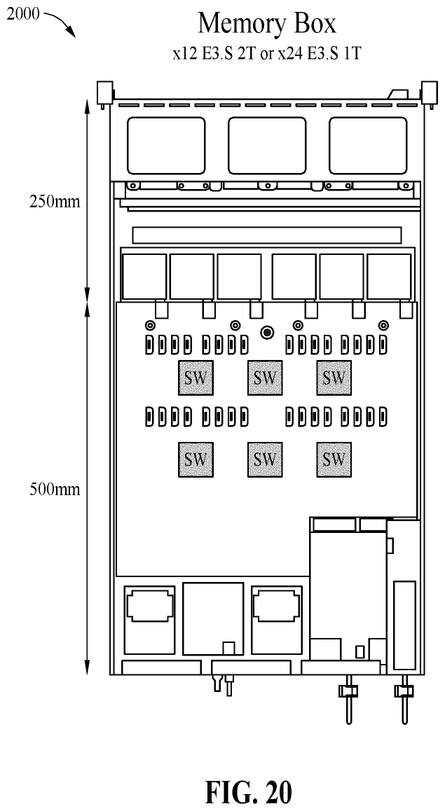

FIGS. 17 and 20 illustrate examples of implementing an electronic apparatus, according to one or more embodiments.

The drawings show an example of a just bunch of memory (JBOM) product with a CXL switch-based memory box structure. FIG. 17 shows an example of a memory enclosure 1700 in which a plurality of memory devices may be accommodated, according to one or more embodiments. FIG. 18 shows an example of a single-stage CXL switch 1800, according to one or more embodiments. FIG. 19 shows an example of a CXL memory device 1900 demonstrating a plurality of memories, according to one or more embodiments. FIG. 20 shows an example of a CXL memory box 2000, including a plurality of memory devices and switches, according to one or more embodiments.

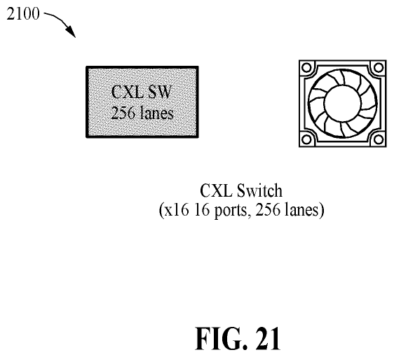

FIGS. 21 to 27 illustrate examples of implementing an electronic apparatus, according to one or more embodiments.

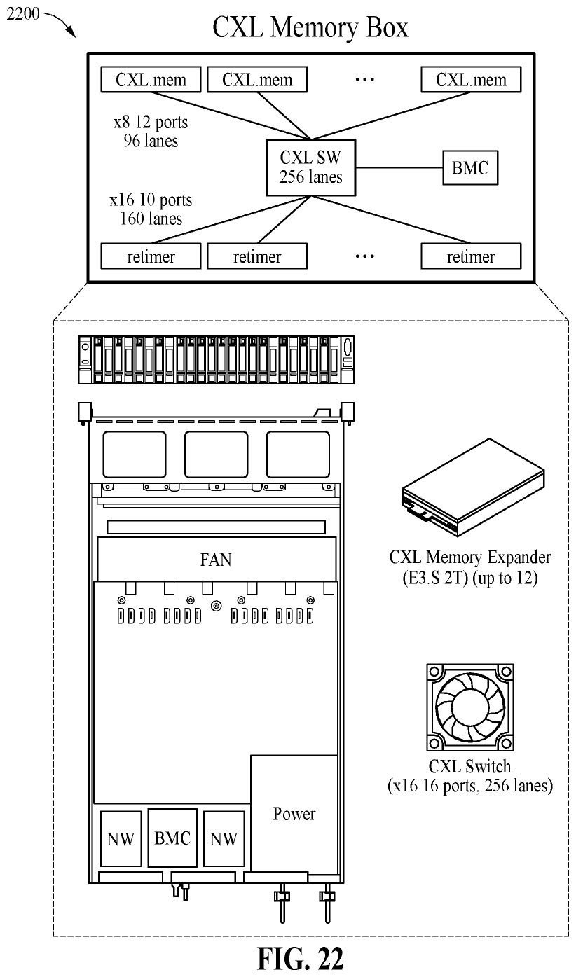

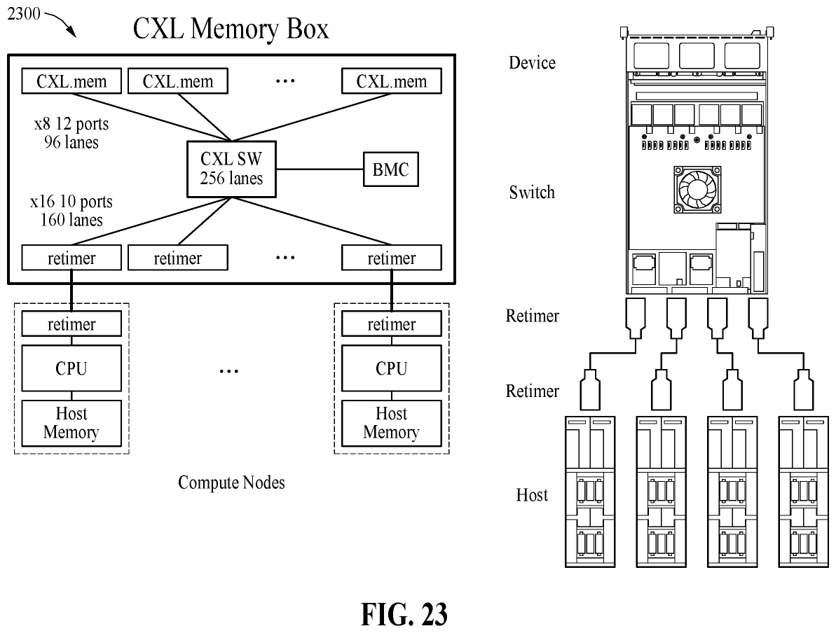

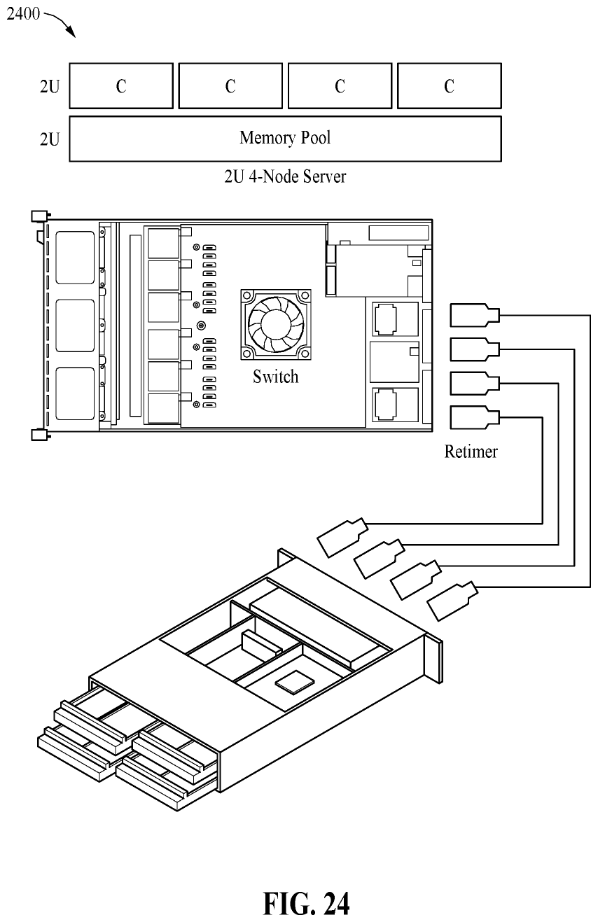

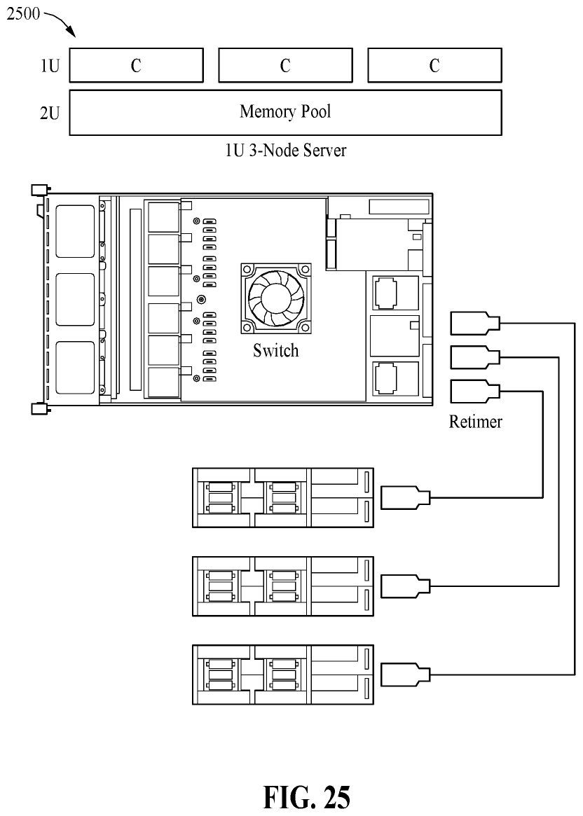

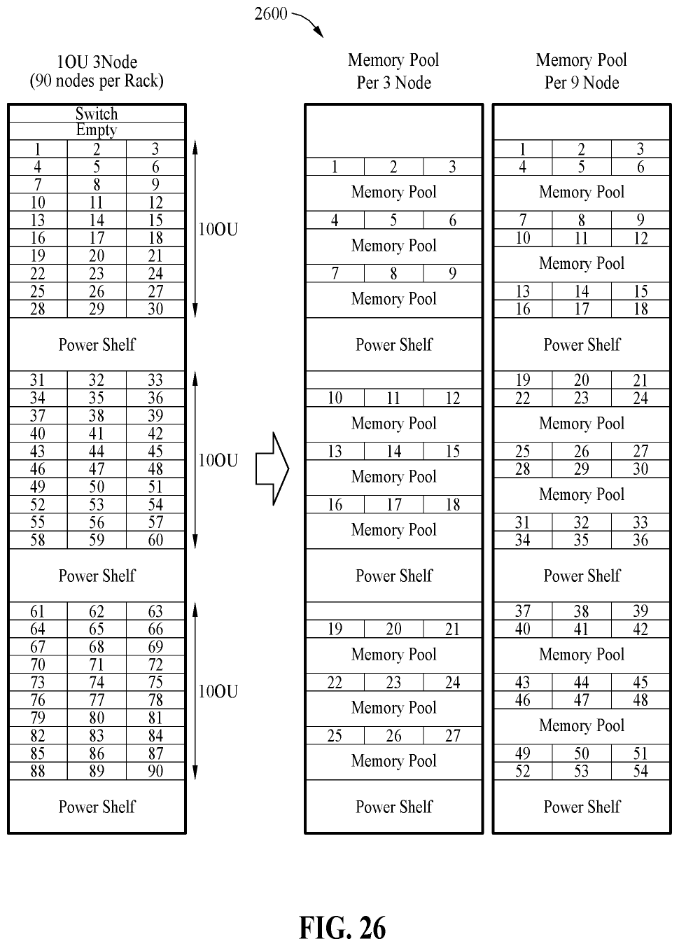

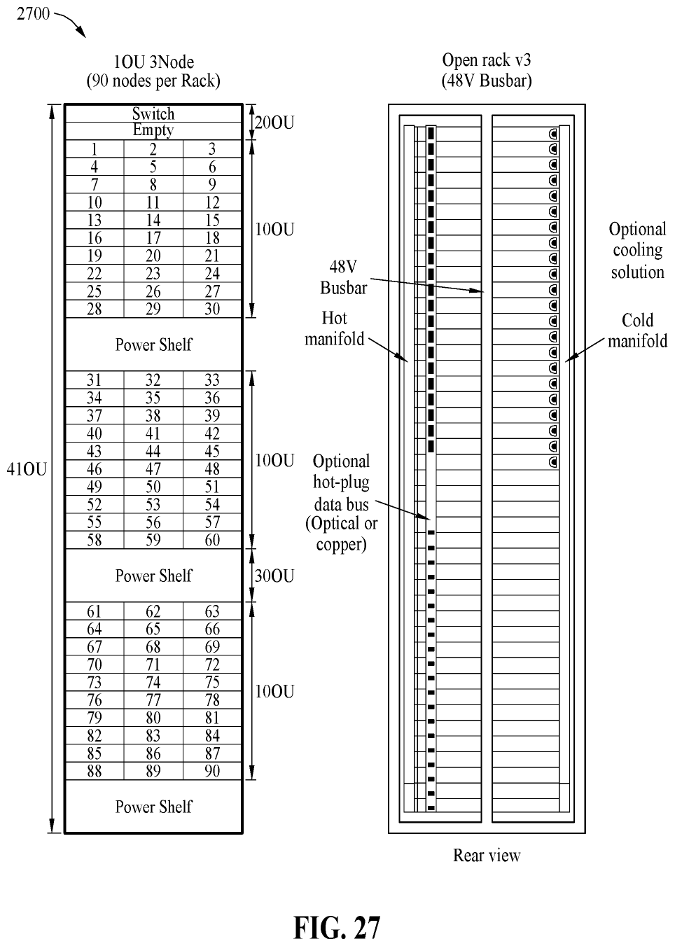

The drawings show an example of a composable infrastructure product with a single CXL switch-based memory box structure. FIG. 21 shows an example of a 256-lane CXL switch 2100, according to one or more embodiments. FIG. 22 shows an example of a CXL memory box 2200, according to one or more embodiments. Devices other than the switch in the CXL memory box 2200 may have a single port and may all be connected to the switch. FIG. 23 shows an example of a CXL memory 2300 with computing nodes, according to one or more embodiments. FIG. 24 shows an example of a 2 U 4-node server structure 2400, according to one or more embodiments. FIG. 25 shows an example of a 1 U 3-node server structure 2500, according to one or more embodiments. FIG. 26 shows an example of a memory box utilizing composable infrastructure system 2600, according to one or more embodiments. FIG. 27 show another example of a memory box utilizing composable infrastructure system 2700, according to one or more embodiments.

The switches, processing devices, processors, processor cores, memory devices, memories, network devices, electronic apparatuses described herein, including descriptions with respect to respect to FIGS. 1-27, are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-27, and discussed with respect to, FIGS. 1-27, that perform the operations described in this application are performed by computing hardware, for example, by processors or computers of any of the switches, memory devices, processor devices, network devices, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. As described above, or in addition to the descriptions above, examples of a non-transitory computer-readable storage medium (and one or memories of any of the memory devices herein) include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and/or any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. An electronic apparatus comprising:
a plurality of processor device-memory device groups, and each of the plurality of processor device-memory device groups comprising a plurality of memory devices respectively comprising one or more memories, a plurality of processor devices respectively comprising one or more processors, and a plurality of switches,
wherein each of the plurality of switches comprises a plurality of ports, and
each of first memory devices included in a first processor device-memory device group of the plurality of processor device-memory device groups is connected to a first subset of ports of one switch of first switches included in the first processor device-memory device group, and to a first subset of ports of one switch of second switches of the plurality of switches included in a second processor device-memory device group of the plurality of processor device-memory device groups.

2. The electronic apparatus of claim 1, wherein the first memory devices are connected to a first switch of the first switches and a first switch of the second switches.

3. The electronic apparatus of claim 1, wherein the first processor device-memory device group and the second processor device-memory device group are disposed to be physically most adjacent to each other.

4. The electronic apparatus of claim 1, wherein the first processor device-memory device group and the second processor device-memory device group are not physically most adjacent to each other but are logically adjacent to each other.

5. The electronic apparatus of claim 4, wherein the first processor device-memory device group and the second processor device-memory device group are disposed to transmit electrical signals between each other.

6. The electronic apparatus of claim 1,
wherein, in each of the plurality of processor device-memory device groups, an equal number of connections exist between a corresponding plurality of memory devices and a corresponding plurality of switches.

7. The electronic apparatus of claim 1, wherein any of the plurality of switches is not connected to another of the plurality of switches.

8. The electronic apparatus of claim 1, wherein a number of the plurality of memory devices in any one of the plurality of processor device-memory device groups is determined based on a condition that a product between a number of the plurality of processor device-memory device groups, a number of switches in a corresponding processor device-memory device group of the processor device-memory device groups, and a number of the plurality of ports of the plurality of switches in the corresponding processor device-memory device group does not exceed a product between the number of plurality of switches in the corresponding processor device-memory device group and a number of a subset of ports in the corresponding processor device-memory device group connected to a corresponding plurality of memory devices.

9. The electronic apparatus of claim 1, wherein numbers of the plurality memory devices in each of the plurality of processor device-memory device groups is equal.

10. The electronic apparatus of claim 1, wherein numbers of the plurality of switches in each of the plurality of processor device-memory device groups is equal.

11. The electronic apparatus of claim 1, wherein a second subset of ports of the one switch of the first switches is connected to a corresponding processor device of the plurality of processor devices.

12. The electronic apparatus of claim 1, wherein a number of the plurality of processor devices is less than or equal to a value obtained by dividing a difference between a total number of ports of the plurality of switches and a total number of ports of the plurality of memory devices by a number of ports of a processor device of the plurality of processor devices.

13. The electronic apparatus of claim 1, wherein a number of the plurality of processor devices is a multiple of a predetermined integer number.

14. The electronic apparatus of claim 1, wherein each of the plurality of switches is a compute express link (CXL) switch.

15. The electronic apparatus of claim 1, wherein each of the plurality of switches is a single-stage switch.

16. The electronic apparatus of claim 1,
wherein each of the plurality of processor devices comprises a plurality of ports, and
each of first processor devices of the plurality of processor devices in the first processor device-memory device group is connected to a second subset of ports of the one switch of the first switches, and a second subset of ports of the one switch of the second switches included in the second processor device-memory device group.

17. The electronic apparatus of claim 1, wherein the electronic apparatus is a storage device.

18. An electronic apparatus comprising:
a plurality of processor device-memory device groups, and each of the plurality of processor device-memory device groups comprising a plurality of memory devices respectively comprising one or more memories, a plurality of processor devices respectively comprising one or more processors, and a plurality of switches,
wherein each of the plurality of processor devices comprises a plurality of ports, and
each of first processor devices included in a first processor device-memory device group of the plurality of processor device-memory device groups is connected to a first subset of one of first switches of the plurality of switches included in the first processor device-memory device group and to a first subset of ports of one switch of second switches of the plurality of switches included in a second processor device-memory device group of the plurality of processor device-memory device groups.

19. An electronic apparatus comprising:
a plurality of memory device groups, and each of the plurality of memory device groups comprising a plurality of memory devices respectively comprising one or memories and a plurality of switches,
wherein each of the plurality of memory devices comprises a plurality of ports, and
each of first memory devices included in a first memory device group of the plurality of memory device groups is connected to a first subset of ports of one switch of first switches included in the first memory device group, and to a first subset of ports of one switch of second switches of the plurality of switches included in a second processor device-memory device group of the plurality of processor device-memory device groups.

20. The electronic apparatus of claim 19, wherein the first memory devices are connected to a first switch of the first switches and a first switch of the second switches.

21. An electronic apparatus comprising:
a plurality of processor device groups, and each of the plurality of processor device groups comprising a plurality of processor devices respectively comprising one or more processors and a plurality of switches,
wherein each of the plurality of processor devices comprises a plurality of ports, and
each of first processor devices included in a first processor device group of the plurality of processor devices groups is connected to a first subset of one of first switches of the plurality of switches included in the first processor device group, and to a first subset of
one switch of second switches of the plurality of switches included in a second processor device of the plurality of processor device groups.

22. An electronic apparatus comprising:
a plurality of processor device-memory device groups, and each of the plurality of processor device-memory device groups comprising a plurality of memory devices respectively comprising one or more memories, a plurality of processor devices respectively comprising one or more processors, and a plurality of switches,
wherein each of the plurality of switches comprises a plurality of ports, and
the plurality of memory devices in one processor device-memory device group of the plurality of processor device-memory device groups is connected to first subsets of ports of each of the plurality of switches in the one processor device-memory device group and another one processor device-memory device group of the plurality of processor device-memory device groups.

23. The electronic apparatus of claim 22, wherein the plurality of memory devices in the other one processor device-memory device group is connected to second subsets of ports of each of the plurality of switches in the other one processor device-memory device group and a third processor device-memory device group of the plurality of processor device-memory device groups.

24. The electronic apparatus of claim 23, wherein the plurality of processor devices in the one processor device-memory device group is connected to third subsets of ports of each of the plurality of switches in the one processor device-memory device group and the other one processor device-memory device group.

25. The electronic apparatus of claim 24, wherein each of the plurality of processor device-memory device groups further comprises a plurality of network device connected to fourth subsets of ports of each of the plurality of switches in the one processor device-memory device group.

26. The electronic apparatus of claim 22, wherein the electronic apparatus is a storage device.
